(19) United States
(12) Patent Application Publication
(10) Pub. No.: US 2011/0253905 A1
(43) Pub. Date: Oct. 20, 2011

(54) SPECIMEN HOLDER ASSEMBLY

(75) Inventors: Guenter Moebus, Sheffield (GB); Guan Wei, Sheffield (GB); Xiaojing Xu, Chandler, AZ (US); Jing Jing Wang, Dublin (IE); Ralph Gay, San Sebastian (ES); Alden James Lockwood, Doncaster (GB); Beverley Inkson, Sheffield (GB)

(73) Assignee: University of Sheffield

(21) Appl. No.: 12/922,415

(22) PCT Filed: Mar. 16, 2009
(86) PCT No.: PCT/GB09/50253

§ 371 Date: Sep. 13, 2010

(30) Foreign Application Priority Data
Mar. 15, 2008 (EP) 08102641.1
Mar. 17, 2008 (GB) 0804771.4

(51) Int. Cl. G01N 23/00

(52) U.S. Cl. 250/441.11; 250/442.11

(57) ABSTRACT

A specimen holder assembly (500) suitable for tomographic inspection of a specimen in a transmission electron microscope comprising: a body portion (501) in the form of an elongate member arranged to be removably insertable into the column of the microscope; and a manipulator portion having a first axis, the manipulator portion comprising: a specimen mount portion (510) configured to support the specimen; a specimen translation assembly operable to translate the specimen mount portion with respect to the body portion; and a specimen rotation assembly (540) coupled to the body portion and to the specimen translation assembly (530), the specimen rotation assembly being operable to rotate the specimen translation assembly relative to the body portion about the first axis.

### FIELD OF THE INVENTION

The present invention relates to a specimen tilt system. In particular but not exclusively the invention relates to a specimen tilt system for use in performing 3D electron tomographical or other high tilt range microscopic inspections of a specimen.

### BACKGROUND

Electron tomography has emerged as a powerful technique for specimen (or ‘sample’) analysis since it enables 3D information in respect of the microstructural characteristics of a specimen to be obtained from two dimensional projection images. According to the technique, projection image data is obtained from a region of interest of a specimen as viewed along a plurality of different directions. Typically, a specimen under irradiation by a beam of electrons is rotated by incremental amounts with respect to the beam about an axis. Images of the specimen are recorded at successive angles of rotation. Images so obtained are subsequently used to reconstuct a 3D model of the specimen.

It is advantageous to be able to record electron projection images from a specimen over a wide range of angles of incidence of the beam with respect to the specimen.

It is well understood that rotation of a specimen on a specimen stage of a tomographic instrument can result in the region of the specimen of interest moving with respect to the field of view by an amount sufficiently large to require translational correction of the specimen position in order to obtain a meaningful series of images. Indeed, the problem of tilt-induced specimen translation is exacerbated at high magnifications (e.g. of the order of 100 k or more). For certain nanoscale inspections of a specimen it is important to be able to view the specimen at magnifications in excess of 100 k.

As a consequence of the undesirable translation of the specimen upon rotation of the specimen, the specimen must typically be translated following each incremental rotation in order to maintain the same spatial position of the specimen with respect to a ‘field of view’ of the instrument. Such translation is often not easy, and sometimes impossible, depending upon how far a region of interest of a specimen has moved with respect to the field of view.

Undesirable movement of the specimen may also occur due to drift and/or backlash of mechanical gears of specimen rotation and/or translation mechanisms.

In some known electron microscopes (in particular side-entry microscopes, see FIG. 1(a)) a specimen 1 is mounted at one end of a holder assembly 7 that is itself inserted into a goniometer assembly 5 of an electron microscope column 2. The goniometer assembly 5 is operable to allow the holder assembly 7 to rotate about an axis 7A of the holder assembly 7, the axis 7A of the holder assembly being arranged to be generally perpendicular to a direction of passage of the electron beam E along the column 2, being a direction parallel to a z-axis (FIG. 1(b)).

For the purpose of the present document, the axis 7A of the holder is aligned along an x-axis (FIG. 1(b)). A y-axis is oriented normal to the x- and z-axes.

The goniometer assembly 5 also allows translation of an end of the specimen holder at which the specimen is positioned along two mutually orthogonal directions with respect to the goniometer in an (x, y) plane generally normal to the direction of passage of the electron beam E.

The goniometer assembly 5 also allows the position (or ‘height’) of the holder assembly to be adjusted along a direction parallel to the z-axis.

This latter positional adjustment allows (i) an adjustment of a focus of an image of a specimen, (ii) movement of the specimen to an optimum plane along the z-axis within the objective lens so as to minimise aberrations, and (iii) positioning of the specimen such that lateral movement of the region of the specimen of interest within the field of view is reduced when the holder assembly is rotated about its axis 7A. The latter adjustment is referred to as ‘eucentric height adjustment’. Simultaneous achievement of eucentric height and height of minimum aberrations is not always possible.

Prior art systems have the disadvantage that rotation of a specimen about the axis 7A of the holder assembly can result in excessive movement of the specimen in the x-y plane. Furthermore, the amount of this movement is typically not predictable. In addition, prior art systems allow tilt of a specimen over only a limited angular range.

A fundamental limitation of known specimen holder assemblies is that tilt is imposed macroscopically on the entire holder assembly. For example, in some side-entry holders one end 7′ of the holder assembly 7 protrudes from the goniometer 5 allowing manual manipulation of the holder assembly 7 (e.g. tilting) by gripping of the end 7′ of the holder assembly 7 and physically turning it.

Prior art systems also have the disadvantage that a specimen or part of a specimen cannot be rotated and translated against a second specimen or a second part of a specimen.

### BRIEF DESCRIPTION OF THE INVENTION

In a first aspect of the invention there is provided a specimen holder assembly suitable for tomographic inspection of a specimen in a transmission electron microscope comprising: a body portion in the form of an elongate member arranged to be removably insertable into the column of the microscope; and a manipulator portion having a first axis, the manipulator portion comprising: a specimen mount portion configured to support the specimen; a specimen translation assembly operable to translate the specimen mount portion with respect to the body portion; and a specimen rotation assembly coupled to the body portion and to the specimen translation assembly, the specimen rotation assembly being operable to rotate the specimen translation assembly relative to the body portion about the first axis.

By tomographic inspection is meant the capture of an image of a specimen at each one of a plurality of different respective rotational positions of the specimen about an axis normal to a direction along which the specimen is viewed.

Some embodiments of the invention have the advantage that a specimen located in a beamline such as an electron, X-ray or proton beamline may be rotated about a precise axis substantially normal to an axis of the beamline without a region of interest of the specimen moving more than a prescribed distance in a direction normal to the axis (a z-axis) of the beamline. In some embodiments this has the advantage that an amount of adjustment of the position of the specimen with respect to the field of view of a microscope is reduced during a process of acquiring tomographic images of the region of interest relative to known tomography systems.

It will be appreciated that some embodiments of the invention are suitable for high tilt range diffraction analysis of a sample using electrons, X-rays and/or proton beams. Thus in some embodiments of the invention tomographical imaging is not performed. Rather, diffraction analysis is performed.

In some embodiments, certain residual translational adjustments of specimen position that are required in order to maintain a region of interest of a specimen at a fixed position with respect to a field of view are readily predictable based on geometrical considerations. Therefore some embodiments of the invention are configured to anticipate and correct for such required adjustments. However, some translational adjustments, such as an amount of translation of a specimen due to ‘drift’ of a specimen, for example due to a change in temperature of an environment in which a microscope is located, or electron beam induced heating of the specimen, are not readily predictable without foreknowledge of the variation in room temperature or the amount of beam-induced heating of the specimen that will occur.

Embodiments of the invention are suitable for use with one or more different instruments such as the transmission electron microscope (TEM), scanning transmission electron microscope (STEM), scanning electron microscope (SEM), focused ion beam (FIB) system, X-ray microscope, proton beam microscope, light optical microscopes and other imaging devices including infra-red (IR) and terahertz imaging devices.

Some embodiments of the invention are suitable for use in fields other than tomography, such as:

(i) rotation and translation of a specimen under a focused electron or ion beam for the purpose of specimen modification (e.g. programmable nanofabrication).

(ii) rotation of a first specimen to a specific orientation relationship relative to a second specimen, prior to establishing contact between the specimens or overlapping projection views, for example as part of an indentation or strain measurement experiment. It is to be understood that in some strain measurement experiments such as moiré techniques strain in a specimen may be measured by viewing the specimen in overlapping projection with a further specimen.

(iii) low depth-of-focus stereology. The ultra-high tilt range which allows inspection of a specimen over a range of tilt angles from 180 to 360 degrees (not normally used for tomography) allows advanced 3D observation techniques not based on computed axial tomography (CAT), but on low depth-of-focus stereology. The equivalence of projection images under 180 degree opposite views no longer applies, and the observation capability of both viewing directions becomes an essential advantage. Related applications in magnetic TEM imaging of samples and holographic imaging also exist.

Preferably the body portion is in the form of a substantially tubular member.

The specimen translation assembly may be provided substantially within the body portion.

The specimen rotation assembly may be provided substantially within the body portion.

Preferably the translation assembly comprises a primary translation assembly and a secondary translation assembly.

Preferably the primary translation assembly comprises at least one piezoelectric actuator.

Preferably the at least one piezoelectric actuator of the primary translation assembly is configured to operate in a stick-slip mode.

Alternatively or in addition the at least one piezoelectric actuator of the primary translation assembly may comprise a four quadrant piezoelectric actuator.

The use of piezoelectric actuators has the advantage that sub-nanometre precision may be achieved in respect of movement of a specimen.

The secondary translation assembly may comprise at least one piezoelectric actuator.

The at least one piezoelectric actuator of the secondary translation assembly may be configured to operate in a stick-slip mode.

Alternatively or in addition the at least one piezoelectric actuator of the secondary translation assembly may comprise a four-quadrant piezoelectric actuator.

The specimen mount portion is preferably coupled to the secondary translation assembly and the secondary translation assembly is preferably coupled to the primary translation assembly whereby translation of the primary translation assembly causes a corresponding translation of the secondary translation assembly.

Preferably the specimen translation assembly is operable to translate the specimen mount portion with respect to the body portion along two non-parallel directions in a plane substantially parallel to the first axis.

More preferably the specimen translation assembly is operable to translate the specimen mount portion with respect to the body portion along three substantially mutually orthogonal directions.

Preferably the specimen rotation assembly comprises a piezoelectric actuator arranged to cause rotation of a shaft member of the rotation assembly, the shaft member being coincident with the first axis, the shaft member being coupled to the primary translation assembly such that rotation of the primary translation assembly about the first axis may be effected by rotation of the shaft member of the rotation assembly.

Preferably the holder assembly further comprises a tertiary translator, the tertiary translator being arranged to cause rotation of the manipulator portion whereby the first axis is rotated about an axis substantially normal to the first axis.

In some embodiments the presence of a tertiary translator has the advantage that the first axis may be rotated into an orientation whereby it is substantially parallel to an axis of rotation of the goniometer.

Preferably the tertiary translator is arranged to cause rotation of the manipulator portion relative to the body portion.

The tertiary translator preferably comprises a piezoelectric actuator assembly coupled to the manipulator portion at a first position of the manipulator portion and arranged to translate a portion of the manipulator portion relative to the body portion in a plane substantially normal to the first axis, the manipulator being arranged to pivot about a second position of the manipulator portion displaced from the first position along the first axis.

The body portion preferably comprises a hollow rod member within which the rotation assembly and primary translation assembly are provided.

Preferably at least a portion of the secondary translation assembly is provided in the rod member.

Preferably the specimen rotation assembly is configured to allow rotation of the specimen mount portion through an angle of at least substantially 250° about the first axis.

More preferably, the specimen rotation assembly is configured to allow rotation of the specimen mount portion through an angle of substantially 360° about the first axis.

The specimen rotation assembly may be operable to rotate the specimen mount portion in steps of less than substantially 1°, preferably less than substantially 0.1°, more preferably less than substantially 0.05°.

The specimen translation assembly may be operable to translate the specimen mount portion in steps of less than substantially 10 nm, more preferably less than substantially 1 nm, still more preferably less than substantially 0.1 nm.

Preferably the holder is operable to translate the specimen mount portion to a position whereby a portion of a specimen mounted in the specimen mount portion intersects the first axis.

The holder may comprise an auxiliary specimen mount portion.

Preferably the auxiliary mount portion is coupled to the body portion.

The holder may be operable to translate a first specimen supported by the specimen mount portion into physical contact with a second specimen supported by the auxiliary specimen mount portion.

Preferably the holder is suitable for insertion into a goniometer portion of a transmission electron microscope.

Preferably the holder is configured to allow the specimen mount portion to be removably inserted into an objective lens of a conventional side-entry transmission electron microscope.

Preferably the holder is configured to allow the specimen mount portion to be removably inserted into the objective lens via a vacuum load-lock.

The holder may have a controller arranged to control the specimen mount portion by means of the specimen translation assembly or the specimen rotation assembly to support the specimen mount portion in a prescribed location.

Thus in some embodiments the controller is arranged automatically to maintain the specimen is a prescribed location upon command by a user. This has the advantage that an accuracy with which a specimen is supported in a prescribed location is increased relative to manual control of the location of the specimen.

The controller may be arranged to control the specimen mount portion by means of the specimen translation assembly and the specimen rotation assembly to support the specimen mount portion in a prescribed location.

The controller may be arranged to maintain a specimen provided in the specimen mount portion in a prescribed location.

The prescribed location may be a location relative to a field of view of an image of the specimen.

Alternatively the prescribed location may be a location relative to a body portion of the holder.

The prescribed location may correspond to a prescribed distance from a specimen supported by the auxiliary specimen holder.

In a second aspect of the invention there is provided materials analysis apparatus in combination with a specimen holder as claimed in any preceding claim.

The apparatus is preferably one selected from amongst a transmission electron microscope, a scanning electron microscope, a scanning transmission electron microscope, an X-ray microscope, an X-ray diffractometer, a proton beam microscope, an ion beam microscope and a synchrotron radiation beamline.

In one aspect of the present invention there is provided a specimen holder assembly suitable for tomographic inspection of a specimen comprising: a body portion; and a manipulator portion having a first axis, the manipulator portion comprising: a specimen mount portion configured to support a specimen; a specimen translation assembly operable to translate the specimen mount portion with respect to the body portion; and a specimen rotation assembly coupled to the body portion and to the specimen translation assembly, the specimen rotation assembly being operable to rotate the specimen translation assembly relative to the body portion about the first axis.

### BRIEF DESCRIPTION OF THE DRAWINGS

Embodiments of the invention will now be described with reference to the accompanying figures in which:

FIG. 1 shows (a) a prior art specimen holder and goniometer assembly of an electron microscope and (b) shows a corresponding orientation of reference axes with respect to the illustration of FIG. 1(a);

FIG. 2 is a schematic illustration of a holder assembly according to an embodiment of the invention;

FIG. 3 is a further schematic illustration of (a) a holder assembly according to the embodiment of FIG. 2 and (b) a portion of a primary translation assembly according to the embodiment of FIG. 2;

FIG. 4 is a schematic illustration of (a) a slip-stick arrangement of a rotational motor used in some embodiments of the invention and (b) a slip-stick arrangement of a primary translation assembly used in some embodiments of the invention.

FIG. 5 is a schematic illustration showing different respective axes of rotation of a holder assembly according to some embodiments of the invention;

FIGS. 6 (a) and (b) are schematic illustrations of holder assemblies having a tertiary translation assembly;

FIG. 7 is a schematic illustration of a holder assembly according to a still further embodiment of the invention;

FIGS. 8 (a) to (c) show embodiments of the invention having different respective configurations of a primary translation assembly;

FIG. 9 shows a perspective cutaway view of a specimen holder assembly according to an embodiment the invention having a rotational position sensor; and

FIG. 10 shows a further perspective cutaway view of the specimen holder assembly of FIG. 9.

### DETAILED DESCRIPTION

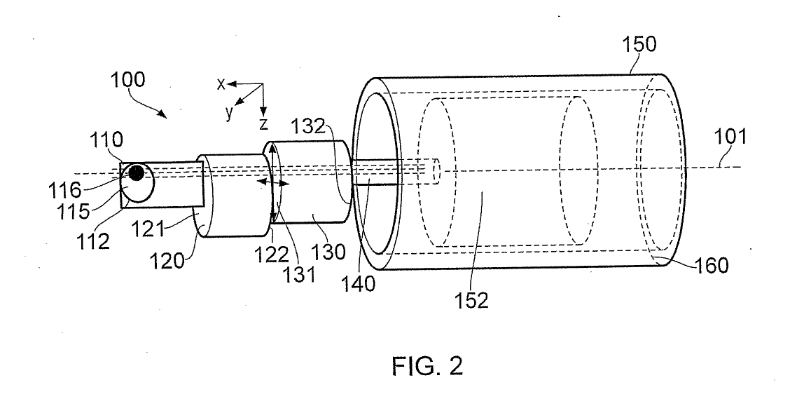

In one embodiment of the invention a holder assembly 100 is provided (FIG. 2) having a specimen mount portion 110 arranged to couple a specimen element 115 thereto. The mount portion 110 has an aperture formed therethrough over which a specimen element 115 is placed and fixedly attached thereto by means of an annular ring element 112.

In some embodiments the mount portion 110 is provided in a modular form and allows fixing of a specimen element 115 thereto in one or more different ways.

In some embodiments a specimen element 115 is provided in the form of a conventional support grid that may be coupled to a rod member which may in turn be coupled to the mount portion 110 of the holder assembly by insertion of the rod into a receiving aperture, for example by screwing into a tapped bore.

Other methods of securing the specimen element 115 to the mount portion 110 are also useful, including spring clips, screw plates and other fixing elements.

In the embodiment of FIG. 2 the mount portion 110 is attached to a specimen translation assembly comprising a primary translation assembly 130 and a secondary translation assembly 120. The mount portion 110 is attached to a first end 121 of the secondary translation assembly 120 being a free end of the secondary translation assembly 120 axially displaced from a second end 122 of the secondary translation assembly 120 that is coupled to a first end 131 of the primary translation assembly 130. A second end 132 of the primary translation assembly 130 is coupled to a shaft 140 of a rotation assembly 150.

The primary translation assembly 130 is arranged to allow translation of the secondary translation assembly 120 in a direction generally parallel to the x-axis and in a direction normal to the x-axis. The secondary translation assembly 120 is arranged to allow translation of the specimen mount 110 along the x-axis and along two mutually orthogonal directions normal to the x-axis.

In some embodiments the primary and secondary translation assemblies 130, 120 are each arranged do allow translation of the specimen mount portion 110 in three substantially orthogonal directions.

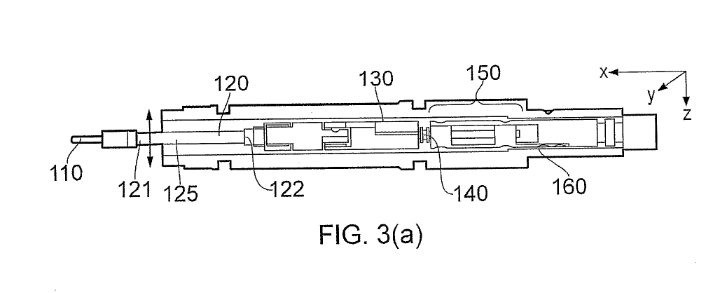

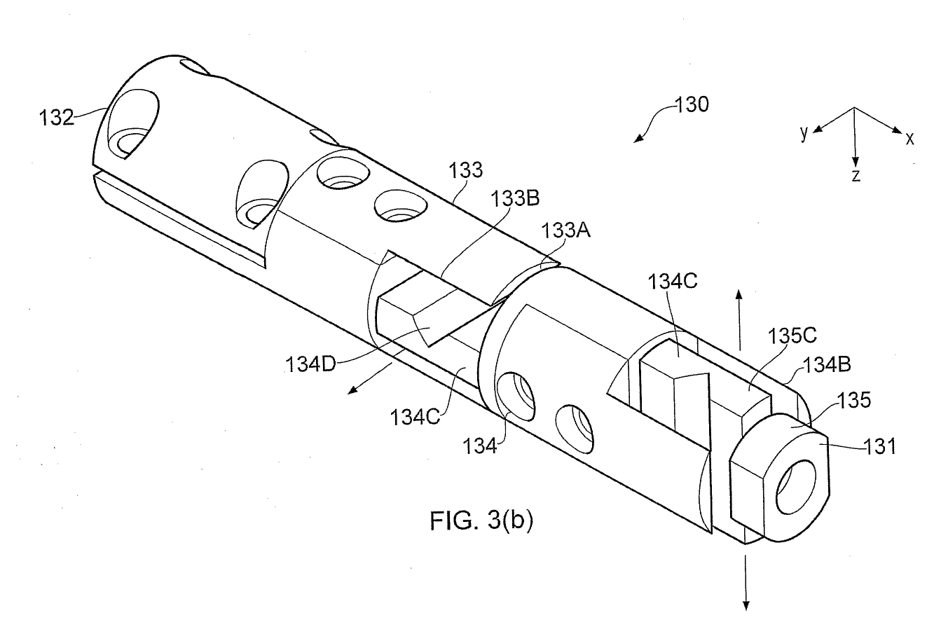

In the embodiment of FIG. 2 the primary translation assembly 130 is a coarse translation assembly having respective translation units each in the form of a pair of shear piezoelectric drives operable according to a stick-slip mode of operation. FIG. 3(a) shows further details of the construction of the holder assembly 100 of FIG. 2 and FIG. 3(b) is an enlarged view of the primary translation assembly 130.

As shown in FIG. 3(b), the primary translation assembly 130 has a first support member 133 and a second support member 134 each in the form of a substantially cylindrical member. An end of the second support member 134 is coupled to an end 133A of the first support member and arranged to be movable with respect to the first support member 133 by means of a slip-stick actuation mechanism. In the embodiment of FIG. 3 the second support member 134 is movable in a direction substantially normal to a longitudinal axis of the first and second support members 133, 134.

In particular, end 133A of the first support member 133 is provided with a groove portion 133B within which a tongue portion 134C of the second support member 134 is slidable. A substantially V-shaped channel 134D is provided in the tongue portion 134C of the second support member 134 in which a bearing is provided (not shown) to facilitate movement of the second support member 134 with respect to the first support member 133 in a direction parallel to an apex of the substantially V-shaped channel 134D.

A corresponding arrangement is provided at an opposite end of the second support member 134 where a third support member 135 is arranged to be movable with respect to the second support member 134. A groove portion 134B is provided along a direction substantially normal to the longitudinal axis of the second support member 134 in a similar manner to the groove portion 133B formed in the end 133A of the first support member 133.

The third support member 135 has a tongue portion 135C formed in an end thereof and is arranged whereby the tongue portion 135C is slidable in the groove portion 134B by means of a slip-stick actuation mechanism. The relative orientations of the tongue 134C and groove 134B of the second support member 134 are such that the second and third support members are movable in substantially orthogonal directions with respect to the first support member 133.

The secondary translation assembly 120 is a relatively fine translation assembly in the form of a four quadrant piezo-tube 125 as shown in FIG. 3(a). The tube 125 is operable to deflect a first end 121 of the tube relative to the second end 122 in a direction parallel to the x-axis and along two mutually orthogonal directions normal to the x-axis by application of suitable potentials to one or more of the quadrants of the tube 125.

It will be appreciated that application of a potential to each of the four quadrants causes translation of the second 122 in a direction parallel to the x-axis.

As described above the translation assemblies 120, 130 are coupled to a shaft member 140 that is in turn coupled to a specimen rotation assembly 150. The specimen rotation assembly 150 has a rotational actuator portion 152 (FIG. 2) provided within a tube member 160 that may be part of or rigidly coupled to a body portion of the holder assembly 100. The rotation assembly 150 is operable by two pairs of piezoelectric elements arranged according to a shear mode of operation to effect rotational motion of the shaft member 140.

The translation assemblies 120, 130 are arranged whereby translation of a specimen 115 may be effected by means of the translation assemblies 120, 130 so as to position an area of interest on or proximate the axis of rotation of the shaft member 140.

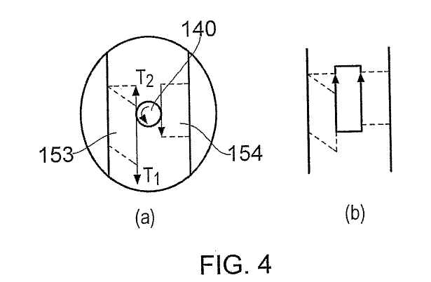

FIG. 4(a) is a cross-sectional schematic illustration of the construction of the rotational actuator portion 152 of the specimen rotation assembly 150. Shaft member 140 of the holder assembly 100 passes through the rotation assembly 150 and is maintained in abutment with two pairs of piezoelectric crystals. One pair of crystals 153, 154 of the rotation assembly 150 is shown in FIG. 4(a). The crystals 153, 154 are provided on diametrically opposite sides of the shaft member 140. The two pairs are mutually spaced apart along the longitudinal axis and fixedly attached to a frame of the rotation assembly 150 that is fixed with respect to the tube member 160.

To generate rotational motion of the shaft member 140, a potential is applied to one of the crystals 153 to induce shear of the crystal whereby a face of the crystal 153 in abutment with the shaft member 140 is caused to displace in a first tangential direction T1 with respect to the shaft member 140. Displacement in the first tangential direction is performed sufficiently slowly to cause rotation of the shaft member 140 about a longitudinal axis of the holder assembly 100 due to friction. In the example shown, rotation of the shaft member 140 occurs in an anticlockwise direction with respect to the orientation shown in the figure.

The crystal 153 is then caused to return to its shape in a sufficiently rapid manner to cause the face of the crystal 153 to slide over the surface of the shaft member 140 such that rotation of the shaft member 140 is not induced. In other words, the face of crystal 153 ‘slips’ with respect to the surface of the shaft member 140.

Following shear of the one crystal 153, a potential is applied to the other crystal 154 in a similar manner thereby to cause further rotation of the shaft member 140. In some embodiments shearing of the pair of crystals 153, 154 can be performed substantially simultaneously. Other sequences of operation are also useful.

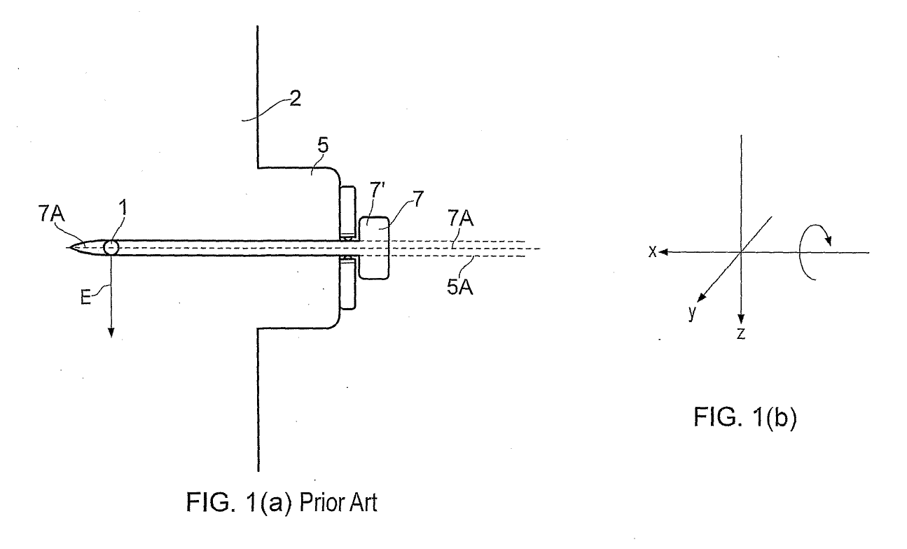

It is to be noted that in the embodiment of FIGS. 1 to 4 the rotation assembly 150 is different from some known high-speed ultrasonic actuators as used for example in some auto-focus camera lens assemblies. In some embodiments the rotation assembly 150 is configured to operate in a step-wise mode and in some embodiments is optimised for incremental rotation of the specimen mount portion to rotational positions having an angular spacing of the order of 1°.

In some embodiments the assembly is arranged to allow incremental rotation of the specimen mount to rotational positions having an angular spacing of 0.1° or less. Other angular spacings are also useful.

In use, the holder assembly 100 may be installed in a goniometer assembly 5 of the column 2 of an electron microscope (FIG. 1). In some microscopes the goniometer assembly 5 is arranged to allow coarse translation of the holder assembly 100 such that a specimen element 115 coupled to the mount portion 110 is within a field of view of the microscope.

In some embodiments the holder assembly 100 is configured such that the specimen 115 will be within the field of view of the microscope at least when the goniometer assembly 5 is in a prescribed configuration. For example, the prescribed configuration may require that the tilt angle of the goniometer is within a particular range, and/or that the position of one or more specimen translation assemblies or rotations assemblies of the holder assembly is/are within a particular range of positions.

Following installation of the holder assembly 100 with a specimen 115 in the mount portion 110, the translation assemblies 120, 130 may be adjusted until a region of interest 116 of the specimen 115 is coincident with the axis of rotation of the specimen rotation assembly 150. It is to be understood that in some embodiments of the invention translation of the holder assembly 100 by means of the microscope's specimen holder assembly translation apparatus may be performed in addition to translation of a specimen by means of the translation assemblies 120, 130 in order to accomplish this.

Once an area of interest of a specimen is coincident with the axis of rotation of the rotation assembly 150 and within a field of view of the microscope, the specimen tilt assembly 150 is actuated and the specimen mount portion 110 rotated to a series of angular positions at each of which a projection electron image of the specimen is recorded. Recorded images are then processed according to known electron tomographic reconstruction algorithms to obtain a 3D representation of the microstructure of the region of interest 116.

It is to be understood that movement of the region of interest 116 within the field of view of the microscope during a course of acquiring a series of images at different respective tilt angles may lead to a requirement to adjust the position of the area of interest. To this end, translation of the specimen using the secondary translation assembly 120 (or in cases of severe movement, the primary translation assembly 130 in addition or instead) may be required.

‘Drift’ of a specimen, for example due to specimen heating or charging, may also be compensated for by this method, in addition to compensation for movement of the area of interest due to mechanical inaccuracies in a construction of the holder assembly 100.

In some embodiments, the primary translation assembly 130 is arranged such that an axis of the piezo tube of the secondary translation assembly 120 is substantially aligned with the axis of rotation of the rotation assembly 150 when the primary translation assembly 130 is set to a datum position with respect to the rotation assembly 150 and the secondary translation assembly 120 is in a prescribed configuration. The prescribed configuration may require the application of a set of default potentials to one or more of the four quadrants of the four-quadrant actuator.

In some embodiments the primary translation assembly 130 is coupled to a shaft that is coupled to the shaft member 140. In some embodiments the primary translation assembly 130 is coupled directly to the shaft member 140.

It is to be understood that in some embodiments of the invention in which specimen rotation and translation assemblies are configured to be insertable into a conventional electron microscope goniometer 5, an axis of rotation 5A of the goniometer 5 may not coincide with an axis of rotation of the rotation assembly 150.

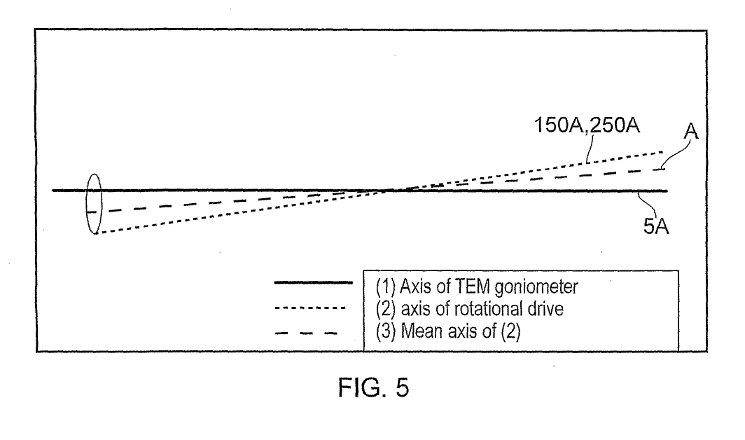

Such a situation is illustrated in FIG. 5, where an axis of rotation 5A of the goniometer 5 is shown, together with an axis of rotation 150A of a specimen rotation assembly 150 of a holder assembly 100 according to an embodiment of the present invention. An ‘average’ axis of rotation A of the rotation assembly 150, being in this example an axis oriented at an equal angle to and coplanar with each of axes 5A, 150A, is also shown.

Some embodiments of the invention seek to overcome the problem of misalignment of axes 5A, 150A by allowing the rotation assembly 150 to be rotated about an axis such that the rotational axis 150A of the rotation assembly 150 is brought into parallel alignment with the axis of rotation of the goniometer 5A.

Furthermore, in some embodiments the position in space of the axis of rotation 150A of the rotation assembly 150 may fluctuate during a process of rotation of the shaft member 140. This can result in a fluctuation of a position of the region of interest 116 of the specimen with respect to the field of view of the microscope.

An ability to adjust a position of the axis of rotation 150A of the rotation assembly 150 in some embodiments allows compensation for fluctuations in specimen position during rotation of the shaft member 140 independently of adjustments to specimen position made using the primary and/or secondary translation assemblies 130, 120.

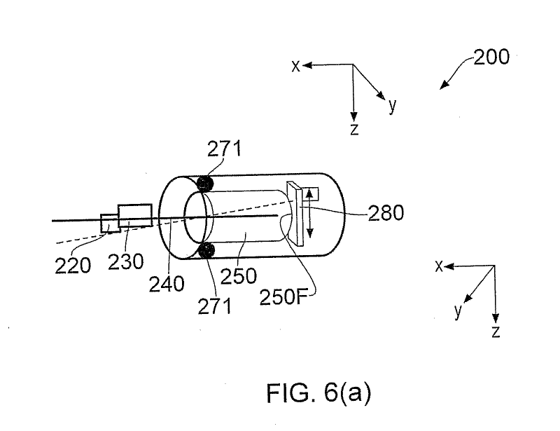

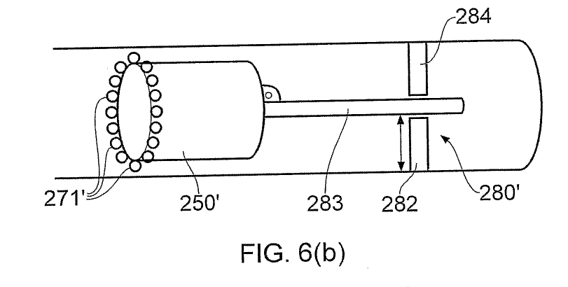

FIG. 6(a) shows an embodiment of the invention in which a holder assembly 200 is provided with features substantially as described with respect to the embodiments of FIGS. 2 to 4. Corresponding features are labelled with similar reference signs, prefixed with the number ‘2’ instead of the number ‘1’.

In addition, a specimen rotation assembly 250 is coupled to a tertiary translation assembly 280 at an end 250F of the rotational assembly 250 opposite an end that is coupled to the primary translation assembly 230.

The tertiary translation assembly 280 is arranged to cause translation of the end 250F of the rotation assembly 250. In some embodiments the tertiary translation assembly 280 comprises a translational actuator such as a slip-stick actuator directly coupled to the end 250F. Other mechanisms for translating the end 250F are also useful.

Bearings 271 are provided that abut a portion of the rotation assembly 250 axially displaced from end 250F and constrain movement of the rotation assembly 250 such that translation of the end 250F of the rotation assembly 250 causes rotation of the axis of rotation of the rotation assembly 250. One pair of bearings 271 are shown in FIG. 6(a); it is to be understood that more than one pair of bearings may be used.

The tertiary translation assembly 280 is arranged to allow a user to adjust the position of the axis of rotation of the rotation assembly 250 such that an area of a specimen of interest to the user remains at a required position during a process of rotation of the specimen by rotation assembly 250.

In some embodiments the action of the tertiary translation assembly 280 is complementary to an action of the primary and secondary translation assemblies 230, 220.

In some embodiments the tertiary translation assembly 280 enables an axis of rotation 250A of the rotation assembly 250 to be moved thereby to intersect an optical axis of the objective lens.

In some embodiments the tertiary translation assembly 280 enables an axis of rotation 250A of rotation assembly 250 and an axis of rotation 5A of the goniometer 5 (FIG. 5) to be aligned substantially parallel to or substantially coincident with one another.

FIG. 6(b) shows an embodiment in which a tertiary translation assembly 280′ is provided in the form of a first piezoelectric actuator 282 operable to deflect a rod member 283 coupled to a specimen rotation assembly 250′ of a manipulator portion of the holder assembly. In the embodiment of FIG. 6(b) the rod member 283 is substantially coaxial with an axis about which the specimen rotation assembly 250′ is operable to rotate a primary translation assembly (not shown).

The first piezoelectric actuator 282 is operable to increase in length thereby to cause rotation of the axis about which the specimen rotation assembly 250′ is operable to rotate the primary translation assembly.

A first resilient member 284 in the form of a spacer block is provided on an opposite side of the rod member 283 to the first piezoelectric actuator 282. When the first actuator 282 expands the rod member 283 is deflected from a datum position towards the first resilient member 284, whereby the first resilient member 284 is resiliently compressed.

When the first actuator 282 is subsequently caused to contract the first resilient member 284 expands towards an uncompressed condition. This causes the rod member 283 to be deflected back towards the datum position. Bearings 271′ are provided to facilitate rotation of the manipulator portion. In some embodiments a second piezoelectric actuator (not shown) and a corresponding second resilient member are provided, oriented substantially normal to first actuator 282 and the axis of rod member 283, the second actuator being arranged to cause rotation of the manipulator assembly about an axis substantially normal to that about which first actuator 282 is arranged to cause rotation of the manipulator assembly.

In some embodiments the first and second actuators are coupled to the rod member 283 such that the first and second resilient members are not required.

In some embodiments, the first and second piezoelectric actuators are in the form of piezo-tube members each being arranged to expand along a longitudinal axis of the respective tube member when a suitable potential is applied to electrodes thereof.

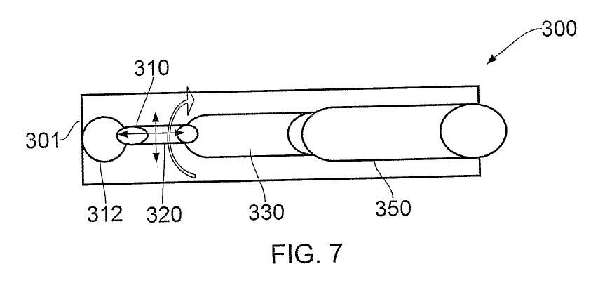

FIG. 7 shows an embodiment of the invention in which a specimen holder assembly 300 is provided having the features of the embodiment of FIG. 2.

Features of the embodiment of FIG. 7 in common with those of the embodiment of FIG. 2 are labelled with similar reference numerals, prefixed with the number ‘3’ instead of ‘1’.

As shown in FIG. 7, in addition to a primary specimen mount 310 a secondary specimen mount 312 is provided. In the embodiment of FIG. 7 the holder assembly 300 has a frame portion 301 to which the secondary specimen mount 312 is attached. The holder assembly 300 is configured to allow primary specimen mount 310 to be translated and rotated relative to the secondary specimen mount 312 by means of primary and secondary translation assemblies 330, 320 and rotation assembly 350.

It is to be understood that in some embodiments rotation of the secondary specimen mount 312 with respect to an electron beam passing through the column 2 of an electron microscope may be effected by rotation of a goniometer 5 in which the holder assembly 300 is mounted, thereby causing rotation of the entire holder assembly 300 whilst rotation of the primary specimen mount 310 with respect to the electron beam may be effected either by rotation of the goniometer in which the holder assembly 300 is mounted or by rotation of the rotation assembly 350 of the holder assembly 300.

In some embodiments the holder assembly 300 is arranged to allow specimens located in the primary and secondary specimen mounts 310, 312 to be provided in the field of view of the microscope simultaneously.

In some embodiments, the assembly 300 allows a specimen held by the primary specimen mount 310 to be brought into physical contact with a specimen held by the secondary specimen mount 312. Thus, holder assemblies of some embodiments of the invention may be used in applications such as nanoscale studies of contact dynamics between materials. Thus some embodiments of the invention may be used in nanoindentation experiments, materials fabrication technologies and metrology.

In some embodiments, the primary translation assembly 330 is configured to allow translation of the secondary translation assembly 320 along one or more orthogonal axes including the x-axis a distance of up to +/−0.5 mm with respect to a datum position.

Other distances are also useful, greater than or less than +/−0.5 mm. In some embodiments the primary translation assembly 330 is configured to allow translation of the secondary translation assembly along one or more orthogonal axes including the x-axis a distance of up to +/−1 mm, whilst in other embodiments this distance is +/−0.25 mm.

In some embodiments the primary translation assembly 330 is configured to allow translation of the secondary translation assembly 320 along three mutually orthogonal x, y, z axes.

In some embodiments the secondary translation assembly 320 is configured to allow translation of the specimen mount along orthogonal x, y, z directions to within 1 nm of a prescribed position within a range of translation of the secondary translation assembly 320.

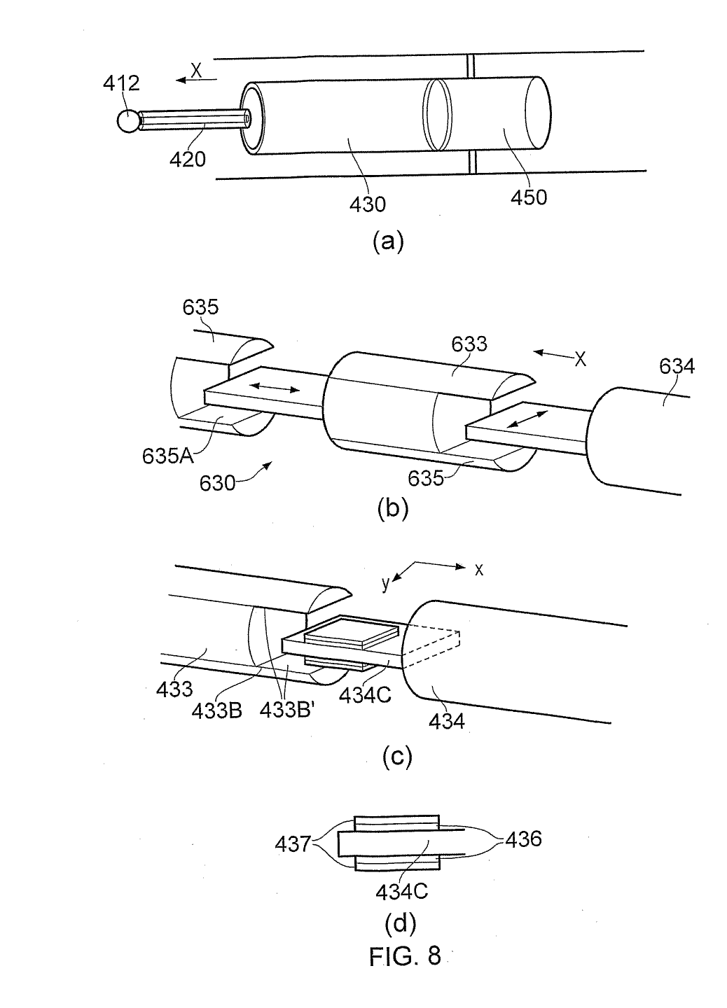

FIG. 8(a) shows an embodiment in which a primary translation assembly 430 is provided in the form of a four-quadrant piezo tube and the secondary translation assembly 420 is provided by a further four-quadrant piezo tube. In the embodiment of FIG. 8(a) the piezo tube of the primary translation assembly 430 is configured to translate the secondary translation assembly along three mutually substantially orthogonal directions, the secondary translation assembly 420 being configured to translate the specimen mount portion 412 in a corresponding manner but over smaller distances due to a difference in size between the piezo tubes of the respective translation assemblies.

In some alternative embodiments the primary translation member 430 is provided by a four-quadrant piezo-tube in addition to a slip-stick actuator. In some embodiments the four-quadrant piezo tube of the primary translation assembly 430 allows translation of the secondary translation assembly 420 by at least 100 microns along an x-axis and at least 100 microns along an axis normal to the x-axis. In some embodiments the distance is at least 500 microns along one or both axes.

It is to be understood that in some embodiments the one or more four quadrant piezo tubes having four quadrants (or ‘sections’) as described herein may be replaced by piezo tubes having a different number of sections.

FIG. 8(b) shows a primary translation assembly according to an alternative embodiment of the invention in which axial translation of the secondary translation assembly 630 (i.e. translation parallel to an x-axis) is facilitated by a slip-stick actuation mechanism 635A in addition to translation along a direction normal to the x-axis by a further slip-stick actuation mechanism similar to those shown in FIG. 3(b). The axial translational motion (parallel to the x-axis) is facilitated by piezoelectric elements arranged to translate the specimen according to a slip-stick actuation mechanism similar to those shown in FIG. 3(b).

FIG. 8(c) and (d) show a primary translation assembly having a combined x- and y-axis translation actuator permitting translation of the secondary translation assembly by means of a single tongue and groove arrangement. In the embodiment of FIG. 8(c) and (d) the primary translation assembly comprises a first support member 433 and a second support member 434 coupled together by means of a tongue portion 434C of the second support member 434 and a corresponding groove 433B of the first support member 433.

The tongue portion 434C is provided with two pairs of plates 436, 437 of a piezoelectric material, one plate of each pair 436, 437 being provided on each of opposite sides of the tongue portion 434C, sandwiched between opposed and substantially parallel inner faces 433B′ of the groove portion 433B of the first support member 433.

Plates of one pair of plates 436 have a crystallographic orientation with respect to the plates of the other pair 437 such that translation of the second support member 434 in mutually orthogonal directions in a plane parallel to the inner faces 433B′ of the groove portion 433B of the first support member 433 may be effected.

In the embodiment of FIG. 8(c) and (d) plates 436 are arranged to translate the second support member in a direction parallel to the y-axis whilst plates 437 are arranged to translation the second support member in a direction parallel to the x-axis. Other arrangements are also useful.

It is to be understood that apparatus according to some embodiments of the invention may be used in a range of different applications including nanofabrication applications. For example, in some embodiments of the invention sharpening of a wire to form a ‘nanotip’ having a diameter of 20 nm or less may be performed by rotation of the wire in a beamline such as a beam of ions. In some embodiments apparatus according to some embodiments is installed in focused ion beam (FIB) milling apparatus.

In some embodiments of the invention means is provided by which a rotational position of the shaft 140 of the rotation assembly 150 may be determined, for example by an electronic controller of the holder apparatus.

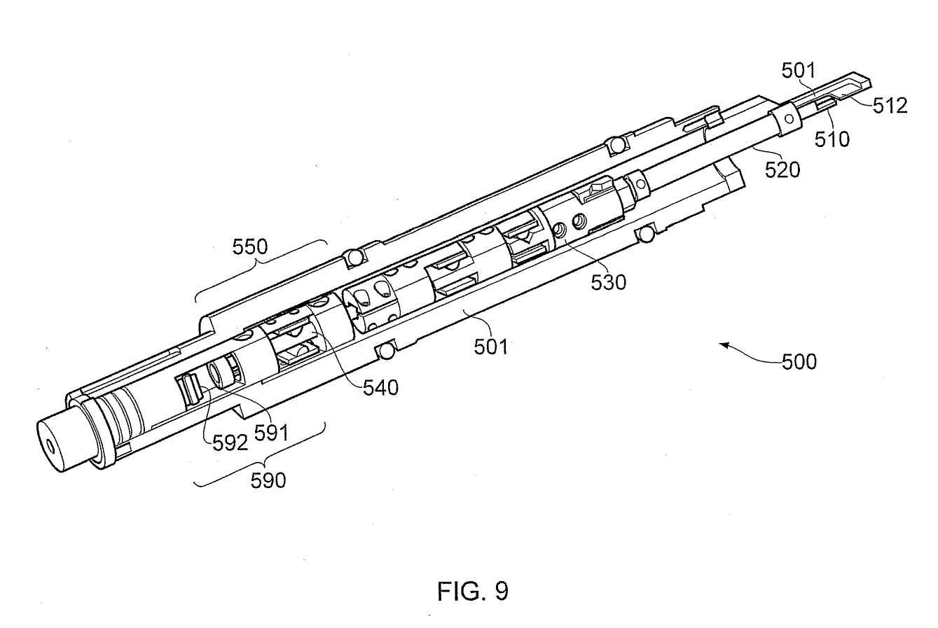

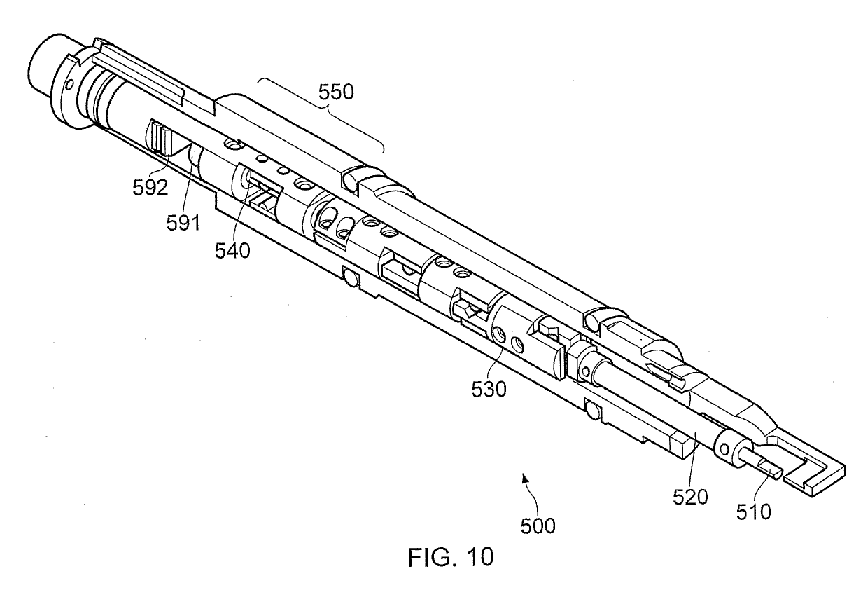

FIG. 9 shows a specimen holder assembly 500 in which a rotational position sensor 590 (Sentron AG Angle Sensor 2SA-10) is provided. The sensor 590 has a ferromagnetic disc portion 591 coupled to the shaft 540 of the rotation assembly 550 of the holder assembly 500 and a CMOS Hall circuit provided in a chip package 592 that is provided in a fixed orientation with respect to the body portion 501 of the holder assembly 500.

The position sensor 590 provides an output corresponding to the rotational position of the shaft 540 thereby enabling positional feedback to be provided to an operator of the holder assembly 500 and/or to controller apparatus such as computing apparatus.

The presence of the position sensor 590 has the advantage that an operator may be confident that the shaft 540 (and consequently the sample holder 510) is in a prescribed position at a given moment in time.

In some embodiments not having a rotational position sensor 590 a rotational position of the specimen mount 510 may be determined based on control signals provided to the rotation assembly 550 such as the number of stick-slip actuation steps performed. A magnitude of each stick-slip actuation step may be measured for a given set of stick-slip actuation parameters (such as applied voltage, rate of switching of the applied voltage etc) to provide a reference magnitude of rotation per stick-slip actuation step under prescribed conditions. The amount of rotation effected in a given direction can then be determined by reference to the number of stick-slip actuations performed in that direction, less the number of actuations performed in a reverse direction.

Such a method has the disadvantage however that the amount by which the shaft 540 rotates in a given direction under a given set of actuation parameters may change over time, for example due to changes in temperature of the rotation assembly and/or ageing of the piezoelectric crystals.

In some embodiments images of the sample or of a portion of the sample holder or any other suitable part of the holder assembly as viewed under the microscope may be recorded and used to provide information on a current position of the sample. The information may be used subsequently to control the holder assembly to move the sample to a required position, and/or maintain the sample in a required position. For example, the information may be used to maintain a given region of a sample supported in the sample holder in a substantially constant position within a field of view of the microscope. Thus, the information may be used to compensate for drift of a specimen, for example thermal drift.

In some embodiments such as that of FIG. 7 or FIG. 9 having a primary specimen mount 310, 510 and a secondary specimen mount 312, 512, the information may be used to control a position of the primary specimen mount with respect to the secondary specimen mount. For example, a controller of the specimen holder assembly 300, 500 may be arranged to move the primary specimen mount 310, 510 to a prescribed location relative to the secondary specimen mount 312, 512. The controller may be arranged to move the primary specimen mount 310, 510 such that a specimen supported by the primary specimen mount 310, 510 is brought into a prescribed position relative to a specimen supported by the secondary specimen mount 312, 512. The prescribed position may correspond to a prescribed distance between the respective specimens, or a position at which contact between the specimens occurs.

As described above the embodiment of FIG. 9 has a specimen mount portion 510 provided at an end of the assembly 500 opposite that at which the rotation assembly 550 is provided. The assembly has an auxiliary (or secondary) specimen mount 512 supported by the body portion 501 of the assembly 500, the auxiliary specimen mount 512 being arranged to support a second specimen. In some embodiments the body portion may be referred to as a frame portion.

It is to be understood that the apparatus may be operable to manipulate the first specimen supported by the specimen mount portion 510 such that the first specimen overlies the second specimen in projection, i.e. in a direction along that of an electron beam passing along the column of the microscope. This feature is of particular interest in experiments such as strain measurement experiments using moiré techniques where strain in a specimen may be measured by viewing the specimen in overlapping projection with a further specimen. As discussed above, a controller of the apparatus may be arranged to manipulate the first specimen into an overlying relationship with the second specimen based on an image of the a specimens provided to the controller by the microscope.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

1. A specimen holder assembly suitable for tomographic inspection of a specimen in a transmission electron microscope, said specimen holder comprising:
a body portion in the form of an elongate member arranged to be removably insertable into the column of the microscope; and
a manipulator portion having a first axis, the manipulator portion comprising:
a specimen mount portion configured to support the specimen;
a specimen translation assembly operable to translate the specimen mount portion with respect to the body portion; and
a specimen rotation assembly coupled to the body portion and to the specimen translation assembly, the specimen rotation assembly being operable to rotate the specimen translation assembly relative to the body portion about the first axis.

2. The holder assembly of claim 1 wherein the body portion is in the form of a substantially tubular member.

3. The holder assembly of claim 1 wherein the specimen translation assembly is provided substantially within the body portion.

4. The holder assembly of claim 1 wherein the specimen rotation assembly is provided substantially within the body portion.

5. The holder of claim 1 wherein the specimen translation assembly is operable to translate the specimen mount portion with respect to the body portion along two non-parallel directions in a plane substantially parallel to the first axis.

6. The holder of claim 5 wherein the specimen translation assembly is operable to translate the specimen mount portion with respect to the body portion along three substantially mutually orthogonal directions.

7. The holder of claim 1 wherein the translation assembly comprises a primary translation assembly and a secondary translation assembly.

8. The holder of claim 7 wherein the primary translation assembly comprises at least one piezoelectric actuator.

9. The holder of claim 8 wherein the at least one piezoelectric actuator of the primary translation assembly is configured to operate in a stick-slip mode.

10. The holder of claim 8 wherein the at least one piezoelectric actuator of the primary translation assembly comprises a four quadrant piezoelectric actuator.

11. The holder of claim 7 wherein the secondary translation assembly comprises at least one piezoelectric actuator.

12. The holder of claim 11 wherein the at least one piezoelectric actuator of the secondary translation assembly is configured to operate in a stick-slip mode.

13. The holder of claim 11 wherein the at least one piezoelectric actuator of the secondary translation assembly comprises a four quadrant piezoelectric actuator.

14. The holder of any one of claims 7 to 13 wherein the specimen mount portion is coupled to the secondary translation assembly and the secondary translation assembly is coupled to the primary translation assembly whereby the primary translation assembly is operable to translate the secondary translation assembly.

15. The holder of claim 1 wherein the specimen rotation assembly comprises a piezoelectric actuator arranged to cause rotation of a shaft member of the rotation assembly, the shaft member being substantially coincident with the first axis, the shaft member being coupled to the primary translation assembly such that rotation of the shaft member causes rotation of the primary translation assembly about the first axis.

16. The holder of claim 15 wherein the holder assembly further comprises a tertiary translator, the tertiary translator being arranged to cause rotation of the manipulator portion whereby the first axis is rotated about an axis substantially normal to the first axis.

17. The holder of claim 16 wherein the tertiary translator is arranged to cause rotation of the manipulator portion relative to the body portion.

18. The holder of claim 16 wherein the tertiary translator comprises a piezoelectric actuator assembly coupled to the manipulator portion at a first position of the manipulator portion and arranged to translate a portion of the manipulator portion relative to the body portion in a plane substantially normal to the first axis, the manipulator being arranged to pivot about a second position of the manipulator portion displaced from the first position along the first axis.

19. The holder of claim 1 wherein the specimen rotation assembly is configured to allow rotation of the specimen mount portion through an angle of at least substantially 250° about the first axis.

20. The holder of claim 19 wherein the specimen rotation assembly is configured to allow rotation of the specimen mount portion through an angle of substantially 360° about the first axis.

21. The holder of claim 1 wherein the specimen rotation assembly is operable to rotate the specimen mount portion in steps of less than substantially 1°, preferably less than substantially 0.1°, more preferably less than substantially 0.05°.

22. The holder of claim 1 provided with means for determining a rotational position of the specimen mount portion.

23. The holder of claim 22 wherein the means for determining a rotational position comprises a magnetic field source and a magnetic field sensor.

24. The holder of claim 23 wherein one of the magnetic field source and the magnetic field sensor is arranged to rotate with the specimen holder portion and the other of the magnetic field source and the magnetic field sensor is arranged to remain in a substantially fixed orientation with respect to the body portion.

25. The holder of claim 23 wherein the magnetic field sensor comprises a Hall probe.

26. The holder of claim 1 wherein the specimen translation assembly is operable to translate the specimen mount portion in steps of less than substantially 10 nm, more preferably less than substantially 1 nm, still more preferably less than substantially 0.1 nm.

27. The holder of claim 1 wherein the holder is operable to translate the specimen mount portion to a position whereby a portion of a specimen mounted in the specimen mount portion intersects the first axis.

28. The holder of claim 1 further comprising an auxiliary specimen mount portion arranged to support a second specimen.

29. The holder of claim 28 wherein the auxiliary mount portion is coupled to the body portion.

30. The holder of claim 28 operable to translate a first specimen supported by the specimen mount portion into physical contact with a second specimen supported by the auxiliary specimen mount portion.

31. The holder of claim 30 operable to translate a first specimen supported by the specimen mount portion into an overlying relationship with the second specimen as viewed in projection in the microscope.

32. The holder of claim 1 suitable for insertion into a goniometer portion of a transmission electron microscope.

33. The holder of claim 1 configured to allow the specimen mount portion to be removably inserted into an objective lens of a conventional side-entry transmission electron microscope.

34. The holder of claim 33 configured to allow the specimen mount portion to be removably inserted into the objective lens via a vacuum load-lock.

35. The holder of claim 1 having a controller arranged to control the specimen mount portion by means of the specimen translation assembly or the specimen rotation assembly to support the specimen mount portion in a prescribed location.

36. The holder of claim 35 wherein the controller is arranged to maintain a specimen provided in the specimen mount portion in a prescribed location.

37. The holder of claim 35 wherein the prescribed location is a location relative to a field of view of an image of the specimen.

38. The holder of claim 35 wherein the prescribed location is a location relative to a body portion of the holder.

39. The holder of claim 35 depending through any one of claims 28 to 31 wherein the prescribed location corresponds to a prescribed distance from a specimen supported by the auxiliary specimen holder.

40. Materials analysis apparatus in combination with a specimen holder as claimed in claim 1.

41. Apparatus as claimed in claim 40 wherein the apparatus is one selected from amongst a transmission electron microscope, a scanning electron microscope, a scanning transmission electron microscope, an X-ray microscope, an X-ray diffractometer, a proton beam microscope, an ion beam microscope and a synchrotron radiation beamline.

42-44. (canceled)
